(19) United States
(12) Patent Application Publication
(10) Pub. No.: US 2026/0355597 A1
(43) Pub. Date: Nov. 12, 2026

(54) DRIVE UNIT FOR A TRAINING DEVICE AND TRAINING DEVICE HAVING SAME

(71) Applicant: ELLIPTI-TECH GMBH, Homburg (CH)

(72) Inventors: Daniel ACKERMANN, Homburg (CH); Jan SCHENKER, Zurich (CH)

(73) Assignee: ELLIPTI-TECH GMBH, Homburg (CH)

(21) Appl. No.: 19/131,960

(22) PCT Filed: Nov. 29, 2023
(86) PCT No.: PCT/EP2023/083558

§ 371 Date: May 22, 2025

(30) Foreign Application Priority Data
Dec. 1, 2022 (EP) 22210918.3

(51) Int. Cl. A63B 69/16; A63B 22/00

(52) U.S. Cl. CPC A63B 69/16; A63B 22/0025; A63B 2069/165; A63B 2225/093

(57) ABSTRACT

The invention relates to a drive unit (4) for driving a wheel (31) of a training device (3a; 3b) by means of a tread force of a user (P) of the training device, wherein the drive unit is designed such that it translates a path, described by a human foot during walking or running into an elliptical path (55) for the foot, wherein the drive unit has a left-hand and a right-hand L-shaped or V-shaped drive arm (9, 10), a left-hand and a right-hand roller system, which each comprise at least one roller (12), wherein the roller systems are rotatably connected to the drive arms, wherein the rollers are received to be linearly movable back and forth in guide rails (2a) of the drive unit or of a frame (2) of the training device, a coupling (50) for transferring the tread force of the user to the wheel, and a left-hand and a right-hand foot pedal (17, 18) for inputting the tread force to the drive unit. The invention furthermore relates to a training device (3a, 3b) designed as an elliptical trainer and having a drive unit (4) according to the invention.

### FIELD OF THE INVENTION

The invention relates to a drive unit for driving a wheel of a training device by means of a tread force of a user and a training device with such a drive unit, according to the respective independent claim.

### BACKGROUND

Exercise equipment for physical training is widely known and available in countless variations depending on the part of the body to be trained. One type of training equipment is designed to train the leg muscles, amongst others. There is training equipment that also trains fitness, for example. Such training equipment can be subdivided, with some of them being similar to bicycles and, as stationary equipment, have only one rear wheel that is driven on the spot by leg muscle power, and as mobile equipment using two wheels. A subtype of the latter devices are so-called elliptical trainers, which are designed as mobile devices. These usually have a rear wheel, a front wheel, a frame, a steering unit and a drive unit. They differ from conventional, bicycle-like training devices primarily in the changed path described by the pedals during a full rotation. While the pedals of conventional bicycle-like devices describe a circular path, elliptical trainers are characterized by a modified path, which is mainly due to a modified drive unit.

It has been found that an elliptical path is gentler on the joints, as the foot and leg movement is smoother and allows a smoother transition between the highest and lowest position of the pedals.

The drive unit of an elliptical trainer with an elliptical path known from WO2008063499 comprises two elongate pedal platforms as drive arms, which are connected at the rear to a crank unit and are attached at the front to guide rails provided in the frame of the elliptical trainer by means of rollers. The circular movement of the crank unit at the rear and the linear movement of the rollers at the front in the guide rails result in an elliptical pedal path during use. During use, the person stands on these pedal platforms and transmits the leg force to the crank unit, which transmits this force to the rear wheel for locomotion.

In a solution known from WO2013120126, an attempt is made to reproduce the natural path of the feet when walking or jogging, which path does not correspond to an ellipse but has a kind of drop shape, whereby the drop is curved upwards. This solution explicitly avoids the elliptical path. The drop-shaped path used here results from the special design of the drive arms in a U-shape. The aim here is also to protect the joints, but the typical path of the foot when walking is reproduced.

Some of the disadvantages of this solution are explained below using the example of the mobile elliptical trainer with an elliptical path. With this mobile elliptical trainer, these pedal platforms are generally relatively long and bulky as the connection to the crank drive is typically located either behind or above the rear wheel. This results in a high step-up height for the user with a relatively high center of gravity, which makes riding at slow speeds and starts/stops more difficult. The long pedal platforms also require long guide rails, which in turn leads to a long wheelbase. The long wheelbase also means that usually only rather small wheels with a diameter of 20 inches are used and is therefore poorly suited for off-road use. Due to the high and long construction, it is therefore not possible to design the conventional type of elliptical trainer for a seated position. A device of this design is therefore also bulky, heavy and difficult to transport. Furthermore, the high position of the user on the elliptical trainer also makes balance more challenging.

### REPRESENTATION OF THE INVENTION

The objective of the present invention is to provide a training device that is compact, versatile and gentle on the joints.

This objective is reached in a first aspect of the invention with a drive unit for driving a wheel of a training device by means of a tread force of a user of the training device. The drive unit is designed in such a way that it translates a path described by the human foot during walking or running into an elliptical path for the foot. The drive unit comprises the following:
a left and a right L-shaped or V-shaped drive arm,
a left and a right roller system, each comprising at least one roller, wherein the left roller system is rotatably connected to the left drive arm and the right roller system is rotatably connected to the right drive arm in the region of a front extremity of the respective drive arm, wherein the at least one roller of each drive arm is accommodated linearly shiftable back and forth in at least one guide rail of the drive unit or in at least one guide rail of a frame of the training device,
a coupling with a left and a right crank for transmitting the user's tread force to the wheel, the coupling being rigidly connected to the left and the right crank at a respective crank point, wherein the left crank is rotatably connected to the left drive arm and the right crank is rotatably connected to the right drive arm in the region of a rear extremity of the respective drive arm,
a left and a right foot pedal for applying the tread force to the drive unit, wherein the left and right foot pedals are rotatably attached to the left and right drive arms respectively.

The objective is reached in a second aspect of the invention with a training device. The training device comprises
a frame with at least one chain stay and a frame segment, wherein a front end of the chain stay is attached to a lower end of the frame segment,
a rear wheel attached to the rear end of the chain stay,
a steering unit or holding unit attached to an upper end of the frame segment, and
a drive unit according to the first aspect of the invention.

The frame segment has at least one lateral guide rail on the left and right sides, in each of which the at least one guide roller of the left and right drive arm of the drive unit is accommodated so as to be linearly shiftable back and forth parallel to a longitudinal axis of the down tube. The coupling of the drive unit is rotatably attached to the frame between the frame segment and the rear wheel. Furthermore, the training device comprises a power transmission element by means of which a tread force of a user of the training device is transmitted to the rear wheel and causes it to rotate. In embodiments, the power transmission element is preferably a chain or a belt.

Due to the L-shaped or V-shaped design of the drive arms in combination with the pedals, which are not integrated into the drive arms but arranged to the side of them, it is possible to provide a drive unit that allows a compact design of the training device and thus enables improved stationary use as well as on the road and off-road. Due to the shorter wheelbase, the training device is easy to transport and can be manufactured not only in an embodiment in which the user has to stand, as in the case of an elliptical trainer with pedals integrated into the arm, but also in a seated version.

In embodiments, the left and right roller systems of the drive unit according to the invention each comprise a lowering arm. The lowering arm is rotatably attached to the at least one roller at an upper end and rigidly attached at the lower end in the region of a front extremity of the respective drive arm, so that the front extremity of the respective drive arm is always lowered relative to the at least one roller. This has the advantage of extending the horizontal elliptical path of the pedal without having to change the length of the cranks. The elliptical path lengthened in this way generally results in a smoother pedaling motion for the user and thus helps to protect the joints. It is preferable if the attachment between each lowering arm and the respective drive arm can be adjusted in such a way that a distance between the front extremity of the drive arm and the at least one roller can be changed by the user. This longer horizontal stroke of the elliptical path enables a more optimal flow of force from the user on the device. This also allows the user to adjust the height of the pedals from the ground depending on their body mass and preferences.

Alternatively, a roller-side leg of the drive arm described below can itself serve as a lowering arm. This means that there is no separate lowering arm, which simplifies the design. However, the attachment is the same as described above.

In embodiments, the attachment between each crank and the respective drive arm is adjustable such that a distance between the rear extremity of the drive arm, i.e. the respective coupling point, and the respective crank point can be changed by the user. In addition to the extension of the horizontal elliptical path resulting from the above-mentioned lowering of the front extremity of the drive arm, an extension of the drive arm (greater distance between the rear extremity of the drive arm and the crank point) also contributes to the longer horizontal elliptical path for the pedals. In other words, changing the length of the drive arm has the following effects: Together with the lowering and shortening of the drive arm, the elliptical path lengthens and vice versa. Shortening the drive arm (smaller distance between the rear extremity of the drive arm and the crank point) results in an advantage with a mobile training device, namely the possibility of using a front wheel with off-road equipment such as off-road tires and a corresponding suspension fork, as the shortening creates more distance between the drive arm and the front wheel.

It is preferred that the coupling is designed as a toothed wheel for a chain drive or as a pulley for a belt drive and can be mounted on a frame of the training device. The drive unit according to the invention can thus be easily adapted to existing frames and rear wheels. It is preferred that the coupling is mounted in front of the wheel of the training device to be driven.

In embodiments, the left and right drive arms each comprise a coupling-side leg, to which the respective left or right crank is rotatably attached, and a roller-side leg, to which the respective left or right roller system is rotatably attached. This creates the aforementioned L-shape or V-shape of the drive arm. It is preferred that the roller-side leg is longer than the coupling-side leg. This contributes to the compactness of the training device as the guide rail can be made shorter, thus shortening the overall length of the training device. For example, the coupling-side leg and the roller-side leg can be rigidly connected or in one piece. To create the L-shape or V-shape, the legs are angled towards each other according to the respective shape. This embodiment has the advantage that the two legs can be manufactured independently of each other and the drive arm can then be adapted to different frames for different training devices and user requirements by varying the connection angle accordingly. Alternatively, the coupling-side leg and the roller-side leg can be bent and merge into one another and be in one piece. This has the advantage that the drive arm is more rigid and therefore more stable. It also reduces the assembly effort and the number of connections such as welding points.

In embodiments, the left and right drive arms each have a reinforcing leg, which additionally rigidly connects the coupling-side leg to the roller-side leg. The reinforcing leg thus forms a triangle with the coupling-side leg and the roller-side leg and increases the stability of the drive arm. It can be straight or curved. It can be attached to the respective free extremity of the coupling-side leg and the roller-side leg, or it can be attached at any point along one or the other or both legs. It can also be manufactured in one piece with the two legs. Alternatively, no reinforcing leg is provided, which simplifies the design,

The pedals are preferably each rotatably attached to the coupling-side leg of the associated drive arm. This has the advantage that their position closer to the rear wheel also allows the use of a seat for the training device, as the pressure surface for the pedals is essentially below the body's center of gravity, which is particularly advantageous for a mobile training device, as the seat also provides an opportunity to rest during longer distances. This is for example not possible with the elliptical trainer mentioned at the beginning with pedals integrated into the drive arm due to the pedal surfaces being positioned towards the front wheel, and this device therefore does not have a seat. The ability to rotate the pedals on the drive arm also results in better ergonomics when pedaling. Finally, the design is more compact, as the pedals are mounted comparatively close to the coupling point. Alternatively, the pedals are mounted at the point where the roller-side leg meets the coupling-side leg.

In embodiments, the position of the pedals can be adjusted horizontally and vertically, providing the user with a further degree of freedom to adjust to their body mass and preferences:
This is achieved horizontally by adjusting the attachment point of the pedals along the longitudinal axis of the respective coupling-side leg.
This is achieved vertically in such a way that the drive unit further comprises an additional connecting piece between the coupling-side leg and the associated pedal. By means of these connecting pieces, it is possible for the user to adjust the distance between the pedal and the coupling-side leg. To implement this function, it is particularly preferred that the connecting piece is a bracket attached to the coupling-side leg and running essentially parallel to it, with fastening means for the pedal. The bracket is preferably fastened at both ends of the coupling-side leg, although it can also be fastened at other points along the coupling-side leg. However, it could also be formed in one piece as part of the reinforcement leg on the coupling side. Alternatively, a vertical connecting part can also be used, which can be attached to the coupling-side leg at only one point. Although this solution is simpler, it only offers reduced stability compared to the bracket. Alternatively, no adjustment of the attachment point of the pedals is provided, which simplifies the design. It has been shown that the adjustment options described above on the extremities of the drive arm (roller-side leg and coupling-side leg) are sufficient to achieve a good adjustment to the user's body mass.

In embodiments, the roller systems each have at least one guide roller and at least one counter roller, which are offset in relation to each other in such a way that each roller can be accommodated in a separate guide rail of the frame of the training device so that it can slide back and forth linearly. The guide roller on the drive arm takes the main weight of the user and slides back and forth on the guide rail. The counter roller absorbs the counter forces and serves to stabilize the drive arm and prevents the drive arm from slipping off the guide rail. It is preferred that the guide roller and the counter roller of a roller system have different diameters, whereby the diameter of the guide roller is preferably larger than the diameter of the counter roller, as the guide roller carries the main weight. This saves material and the guide rail can be made smaller. Particularly preferably, two guide rollers are provided and the left and the right roller system further each comprise at least one safety roller that is accommodated so as to be shiftable back and forth, which is arranged in relation to a position of the guide roller(s) in such a way that it prevents the roller system from jumping out or being unintentionally removed from the guide rail. The safety roller is particularly preferably provided on an opposite side of the guide rail in relation to the guide roller.

The preferred embodiments of the training device according to the invention with a drive unit according to one or more of the features described above are explained in the context of the description of the figures.

### BRIEF DESCRIPTION OF THE DRAWINGS

Further embodiments, advantages and applications of the invention are apparent from the dependent claims and from the following description with reference to the figures. It is shown in:

FIG. 1 the typical path of the human foot when walking,

FIG. 2 the typical path of the foot when cycling,

FIG. 3 the path of the foot in the present invention,

FIG. 4 a side view of a mobile training device according to the invention in a first position of the pedals,

FIG. 5 a side view of the mobile training device according to FIG. 4 in a second position of the pedals,

FIG. 6 a side view of a stationary training device according to the invention,

FIG. 7 a side view of a drive unit according to the invention,

FIGS. 8-11, three embodiments of the drive arm of the drive unit from FIG. 7, and

FIG. 12 a coupling with cranks of the drive unit according to FIG. 7,

FIG. 13 a perspective view of a preferred embodiment of the drive unit according to the invention on a guide rail,

FIG. 14 a side view of the embodiment in FIG. 13,

FIG. 15 a cross-sectional view of a roller system of the drive unit from FIG. 13 on the guide rail, and

FIG. 16 a perspective view of the roller system from FIG. 15 without guide rail.

### WAYS TO CARRY OUT THE INVENTION

Position terms such as left and right or up and down refer to the usual meaning in connection with a bicycle.

Terms related to the elliptical path refer to the mathematical definitions of an ellipse.

The term “path” refers to a path actually described by the pedal, e.g. the contour of an ellipse. In contrast, the term “way” refers to the horizontal or vertical projection of the path or generally to a linear path.

In the present context, a coupling is only defined as a drive-side part, e.g. as a gear rack/chainring of the drive unit, in order to distinguish between the drive unit assembly and the rest of the training device, which comprises the counterpart (sprocket/hub) arranged on the rear wheel.

In the context of the present invention, “shiftable” in relation to rollers means that they roll back and forth in the guide groove, causing the bearing of the respective roller to undergo a linear displacement.

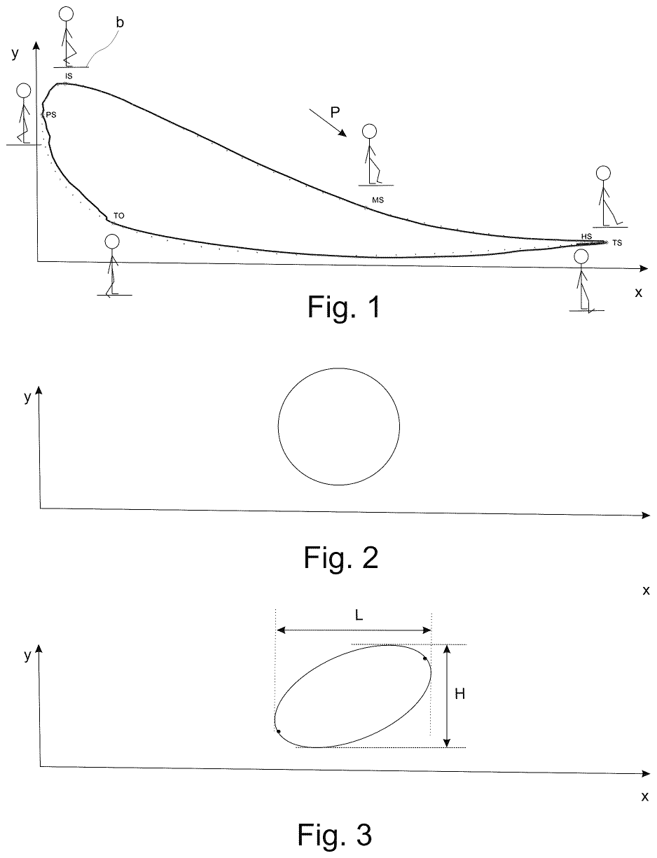

FIG. 1 shows a schematic representation of the typical path that a human foot describes when walking. Here, x denotes the walking direction and y the height of lift of the foot in relation to the heel. The leg position of the right leg of person P is shown schematically and is intended to illustrate approximately the position, in particular in relation to a floor centerline b between the feet. The movement or path begins with a so-called initial swing IS, in which the leg is lifted for the stride. This is followed by a so-called middle swing MS in which the leg is moved forward until the so-called final swing TS. This is immediately followed by a heel strike HS, where the foot is on the ground for the duration of the movements described above of the other foot. This is followed by a so-called toe-off TO while the other foot is now in contact with the ground, followed by a so-called forward swing PS while the other foot is completely on the ground. During the forward swing, the foot is lifted until it reaches the initial swing position, after which the process is repeated. The path shown in FIG. 1 is referred to in the present context as an upwardly curved drop-like path and was already mentioned at the beginning in the context of a prior art document.

FIG. 2 schematically shows the typical path that a human foot describes when riding a bicycle. This path is a simple circular path that is defined by the toothed wheel of the bicycle, also known as the chainring.

FIG. 3 shows an elliptical path described by a human foot when using the training device according to the invention. The training device is also referred to below as an elliptical trainer. It is thus characterized in that a pedal describes an elliptical path during a complete pedal rotation, in which, in the case of the present invention (see FIG. 5), a front apex of the ellipse is higher than a rear apex of the ellipse (black dots in the figure). It is generally preferred and the dimensions of the elements of the drive arm and the guide rail are selected such that the main axis of the ellipse, which connects the two drawn vertices, is longer than twice the length of the cranks and/or longer than a coupling-side leg of the drive arm. The main axis of the ellipse corresponds to a linear path that the drive arm covers on the guide rail during the complete pedal rotation. This enables an ergonomic elliptical motion sequence despite the smallest possible space.

It is easy to deduce from the synopsis of FIGS. 1 to 3 that the load on the feet or the foot and leg joints varies due to the different path. In the walking pattern in FIG. 1, it is generally known that this path is a natural path for the feet, but it is also known that the load can vary greatly due to different misalignments of the feet, etc. and is therefore not always the gentlest alternative for the joints when exercising. With the circular track in FIG. 2, the “drop height” between the top point of the track and the bottom point of the track is very high and results in a correspondingly high braking force during the transition between the top position and the bottom position, which may cause a high load on the knees. The elliptical path in FIG. 3 results in a smoother transition between the top position and the bottom position and therefore a smaller force gradient, which has a gentle effect on the joints. This aspect is particularly important when exercising.

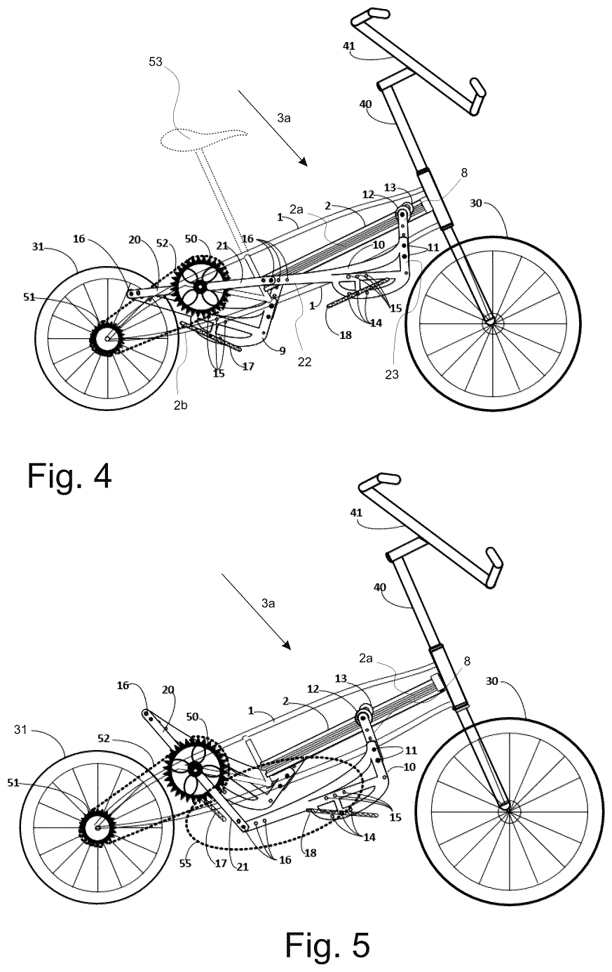

FIG. 4 and FIG. 5 show a side view of a mobile training device, with a first position of the pedals being shown in FIG. 4 and a second position of the pedals being shown in FIG. 5. The first position corresponds to the position in the foremost position of the right pedal 18 and the second position corresponds to an intermediate position of the pedals. Furthermore, a saddle 53 is shown in FIG. 4 to illustrate this option by way of example. The saddle can also be provided for a stationary training device.

The training device 3a comprises a frame 1 with a frame segment 2 and two chain stays 2b to the left and right of a rear wheel 31 attached to both chain stays. A front end of the chain stays 2b is attached to a lower end of the frame segment 2. Depending on the design of the mobile training device 3a, the frame segment 2 can correspond, for example, to a down tube or a top tube of the frame, whereby the designations correspond to technical terms for a bicycle. In the present case, the chain stays are attached to the lower end of the frame segment via a cross strut. Direct attachment is of course also possible if the frame is designed accordingly, e.g. in the form of a monocoque frame.

Furthermore, a steering unit or holding unit attached to an upper end of the frame segment 2 is provided, comprising a steering rod 40 and a handlebar 41, which are connected to a front wheel 30.

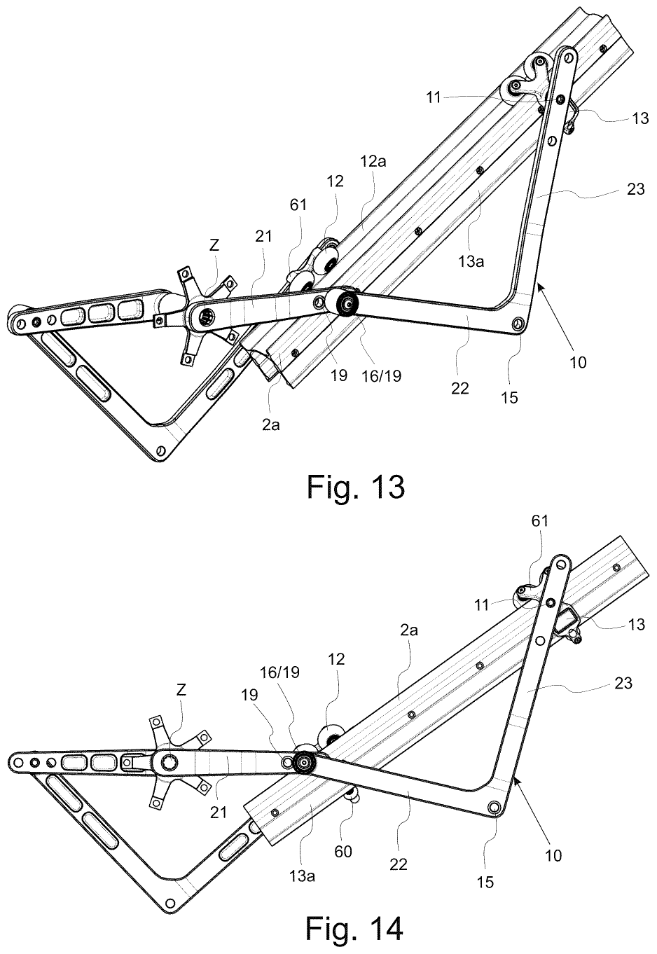

The training device also comprises a drive unit 4 (FIG. 7). The drive unit 4 comprises a coupling 50 to which a left and a right crank 20, 21 are attached at a crank point Z (FIG. 7). A left and a right drive arm 9, 10 are each attached to the cranks 20, 21 at a coupling point 16, 19. Each drive arm has a guide roller 12 at its front extremity attached via a lowering arm 8 in a lowering arm attachment point 11 and a counter roller 13. Each roller is held in its own associated guide rail 2a and can be moved back and forth linearly along the longitudinal axis of the frame segment, which extends obliquely upwards towards the front. It applies generally to all embodiments of the invention that all the rollers present move back and forth in associated guide grooves, which is described by way of example in the embodiment shown in FIGS. 13-16. The drive arms each have a coupling-side leg 22 and a roller-side leg 23, which in this embodiment are in one piece and L-shaped. Pedals 17, 18 are provided on the left and right, which are each attached to the associated drive arm at pedal attachment points 14 or 15. The elliptical path 55 described by the pedals is shown in FIG. 5 with the dashed ellipse. Details of the individual elements of the drive unit 4 for the specific embodiments shown in the figures are described in the context of FIGS. 7-11.

The frame segment 2 thus has two guide rails 2a on the left and right sides, in each of which a guide roller 12 and a counter roller 13 of the left and right drive arm 3b of the drive unit are accommodated so as to be linearly shiftable back and forth parallel to a longitudinal axis of the frame segment 2. However, only one guide rail for the guide roller per side of the frame segment could also be provided, which is described in detail in connection with the embodiment of FIGS. 13-16. In one variant of the invention, the at least one guide rail 2a is part of the drive unit 4. In this case, the frame segment 2 of the training device is designed in such a way that the guide rail 2a can be attached thereto, so that the frame segment 2 and the guide rail 2a form a fixed structural unit. Appropriate fastening means are provided for this purpose. Advantageously, the drive unit can thus be adapted to a conventional frame segment 2 with less effort. In another variant of the invention, the at least one guide rail 2a is part of the training device and not part of the drive unit 4. In this case, the guide rail could either be permanently mounted on the frame segment 2 or it could be formed in the frame itself, so that, for example, guide grooves for the rollers of the drive unit are formed in the frame segment itself. The advantage of this is that there is no need for any connecting devices and the construction of the frame 1 with the guide rails is more stable.

The coupling 50 of the drive unit 4, which is designed as a toothed wheel, is rotatably attached to the frame 1 between the frame segment 2 and the rear wheel 31 and is connected to a sprocket 51 and a hub of the rear wheel via a chain 52 as a power transmission element to drive the rear wheel 31. A belt drive could also be provided instead of a chain drive. With this design, the tread force of the user of the training device is transmitted to the rear wheel and causes it to rotate.

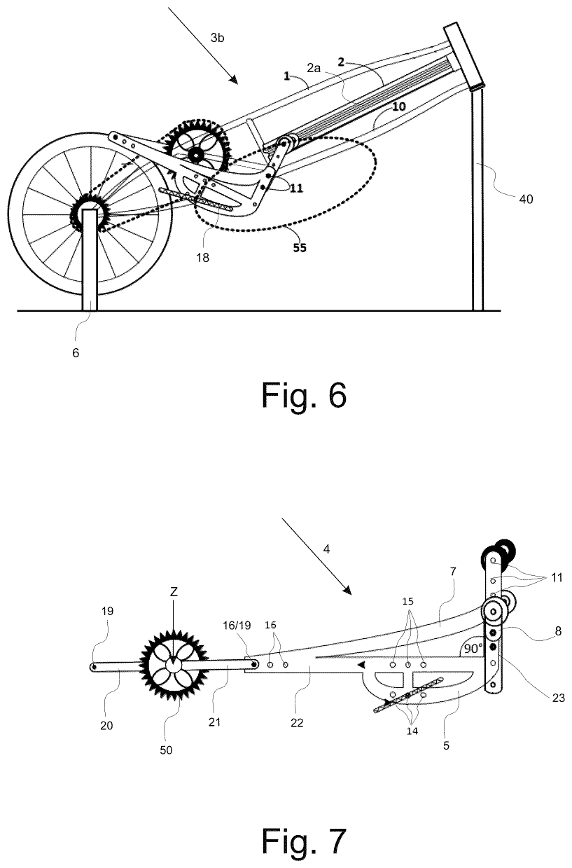

FIG. 6 shows a side view of a stationary training device 3b. This figure shows a further third position of the pedals, in which the right pedal 18 is in the rearmost position and which also applies to the mobile training device. In other words, the rollers 12, 13 describe a linear movement between the uppermost extremity of the guide rails (FIG. 4) and the lowermost extremity of the guide rails (FIG. 6). The stationary training device 3b differs from the mobile training device in that it has no front wheel. Instead, a support device for the floor is provided. Furthermore, no steering unit is provided but only a holding unit with a support bar and a holding bar (not shown) to support the user's hands. Finally, a holding device 6 is provided for the rear wheel, which supports it raised from the ground so that the rear wheel can be turned on the spot without contacting the ground.

FIG. 7 shows a side view of a drive unit 4 with the elements already described. It is clearly visible in this figure that the drive unit has many adjustment options. They are advantageously designed to provide the user with the optimum setting for their specific preferences and body mass. The drive unit shown here is the version without its own guide rails. In this case, the guide rails are part of the training device.

A first possibility is to adjust the coupling point 16, 19 to adapt the step length. Throughout the document, the holes in the drive arm are labeled 16 and the holes in the crank are labeled 19, with 16/19 in the figures illustrating that one hole of each of the two elements contributes to the connection. A second option is to adjust the pedal height by selecting either pedal attachment points 15 on the coupling-side leg of the drive arm or pedal attachment points 14 on the reinforcing arm 5 (bracket). The pedal position can additionally be adjusted in the horizontal direction by selecting one of the various attachment points on the respective leg. Finally, the lowering height of the drive arm 8 can be adjusted by selecting one of the lowering arm attachment points 11. It should be noted that the lowering arm 8 is optional and, in particular, is supplied but can be attached and removed again at any time. The different levels of lowering of the drive arm by means of the lowering arm 8 are used to adjust the height for different body sizes and also for adjustment on steep terrain for more ground clearance. In addition, the elliptical path for the foot pedal is extended, as shown in connection with FIG. 12 by means of an example.

As already mentioned, the legs 22, 23 of the drive arms have an L-shape in the embodiments shown, which is illustrated by the 90° angle in FIG. 7. However, other angles in which the legs form a V-shape are also possible.

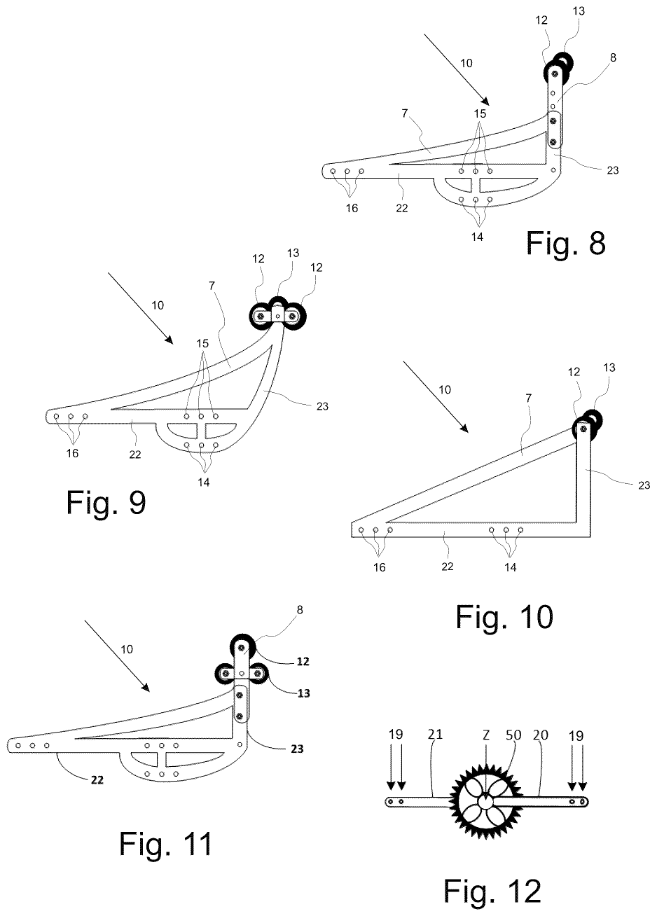

FIGS. 8-10 show examples of three different embodiments of a right-hand drive arm of the drive unit 4 from FIG. 7. As mentioned, a guide roller 12 and a counter roller 13 can be used. The counter roller is offset inwards towards the frame segment, as can be seen from the figures. It can be offset inwards on the same axis as the guide roller or, as shown in the figures, offset inwards on its own axis. Accordingly, the frame segment has two guide rails on the left and two guide rails on the right, wherein in one of the guide rails the at least one guide roller of the left or right drive arm of the drive unit are accommodated so as to be linearly shiftable back and forth parallel to a longitudinal axis of the frame segment, and in the other guide rail at least one counter-roller of the left or right drive arm of the drive unit, which is axially offset relative to the guide roller, is accommodated so as to be linearly shiftable back and forth parallel to a longitudinal axis of the frame segment. FIGS. 8 and 10 show such a configuration, while FIG. 9 shows a further variant in which two guide rollers and a counter roller are provided. In this case, the two guide rollers 12 run in the same guide rail.

However, it is of course also possible to use only one or more guide rollers and no counter roller. In this case, in order to prevent the guide roller from slipping off the guide rail, the guide rail could, for example, be designed as a U-profile so that the outer U-leg prevents this. Preferably, however, a safety roller is provided, which is described by way of example in connection with the embodiment according to FIGS. 13-16 and is intended to apply to all embodiments. The rollers are preferably made of polyoxymethylene (POM), rubber or polyurethane with or without a nylon core, whereby different Shore hardnesses can be used, depending on the weight to be carried by the user. Rubber hardnesses are known and are not described further here. Polyoxymethylene is particularly preferred as it has high mechanical strength and rigidity, but is easy to process as the rollers can be milled to size. In contrast, PU rollers, nylon rollers, etc. have to be manufactured in complex processes.

FIGS. 8-10 also show various exemplary embodiments of the reinforcing leg 7, which can be straight (FIG. 10) or curved (FIGS. 8, 9). FIGS. 8, 10 also show drive arms with a coupling-side leg 22 and a roller-side leg 23 that form an L-shape, whereas in FIG. 9 they form a V-shape. Furthermore, a lowering arm 8 is provided in the embodiment shown in FIG. 8, while no such arm is provided in the embodiments shown in FIGS. 9 and 10.

FIG. 11 shows another variant of the roller arrangement. Here, two counter rollers 13 and a guide roller 12 arranged centrally above the two counter rollers and offset inwards and vertically upwards are provided. The three rollers are attached to the lowering arm 8. This distributes the resulting torsional forces over two planes. Of course, features of the embodiments in FIGS. 8-11 can be combined as far as technically feasible.

FIG. 12 shows a coupling with cranks 20, 21 of the drive unit according to FIG. 7. The cranks are attached to the chainring at crank point Z. The coupling of the cranks to the respective drive arm on the coupling side can be varied in the coupling points 16, 19, the number of which can of course also be greater than shown. In the embodiment shown in this figure, adjustment at the crank is also possible by providing several holes 19 in the crank, in contrast to the embodiment shown in FIG. 7, in which only one hole is provided in the crank. For example, the distance between the coupling points 16, 19 and the crank point Z can be varied in a range between 20 cm and 25 cm. The closer the coupling-side leg is attached to crank point Z, the “shorter” it becomes, i.e. the lever to point Z becomes shorter. This has the effect that the distance between the roller-side leg and the front wheel is greater (in the mobile training device version). Conversely, the leg on the coupling side becomes longer if it is attached further away from point Z. This has the effect that the distance between the roller-side leg and the front wheel is smaller (in the variant of the mobile training device). As a result, an extension of approx. 5-10% can be achieved. For example, if the length of the coupling-side leg is 46 cm and the crank length is 25 cm, shortening the coupling-side leg by 6 cm from 46 cm to 40 cm and lowering the front extremity of the roller-side leg by 10 cm will lengthen the pedal way on the elliptical track by 5%-10%. Such a shortening is advantageous for taller users.

In the previous embodiments, the coupling-side leg 22 was longer than the roller-side leg 23. However, as mentioned at the beginning, it is preferred if the roller-side leg is longer than the coupling-side leg, which is implemented in the following embodiment. However, this preferred length ratio could also be used in the previous embodiments and vice versa. For this purpose, only the preferred angle of 90° between the two legs would have to be changed.

FIG. 13 shows a perspective view of a preferred embodiment of the drive unit according to the invention on a guide rail and FIG. 14 shows a side view of the embodiment of FIG. 13. The explanations of the previous embodiments of the drive unit also apply to the embodiment described below, except for the features explicitly explained below.

In this embodiment, the left and right roller systems each have two guide rollers 12 which are both accommodated in a common first guide groove 12a of the guide rail so that they are linearly shiftable back and forth. The counter roller 13 is accommodated in a second guide groove 13a so that it is linearly shiftable back and forth. Furthermore, a safety roller 60 is provided for each roller system, which is accommodated in a third guide groove 60a of the guide rail so as to be shiftable back and forth. It is arranged in relation to a position of the guide rollers in such a way that it prevents the roller system from jumping out or being unintentionally removed from the guide rail. This is particularly advantageous in the mobile version of the training device with the drive unit to ensure that the roller system does not jump out of the guide rail in the event of a pothole in the road, for example.

Another difference, e.g. to FIG. 7, is that the drive arm is simplified here. For example, only a single pedal attachment point 15 is provided and no reinforcing leg. It was noticed that the lowering arm attachment points 11 and the coupling points 16, 19 are completely sufficient for adaptation to different users. With reference to FIG. 3, the adjustment of the lowering arm attachment point 11 causes a change in the ellipse height, whereby the point 11 closest to the free end of the roller-side leg corresponds to the lowest lowering of the drive arm and the greatest ellipse height H. This adjustment option allows adaptation to the height of the user. The adjustment primarily changes the “thickness”, i.e. the height H of the ellipse in relation to the y axis. Lowering also results in a slight forward rotation of the ellipse while the coupling point 16/19 remains unchanged. Lowering is particularly advantageous for taller users. Adjusting the coupling point 16/19 results in an adjustment of the ellipse length L (FIG. 3) and thus the stride length, whereby the attachment point closest to the crank point Z corresponds to the shortest stride length. It should be noted that for all embodiments of the drive unit according to the invention, it is also possible to provide only exactly one hole 19/16 in the crank 20 and/or the coupling-side leg 22. In particular, only a single coupling point 16/19 can be provided without adjustment options. In this case, cranks of different lengths can be provided, for example, depending on the height or height ratios of different users.

A further simplification is that in this embodiment no separate lowering arm is provided, but the roller-side leg 23 of the drive arm is at the same time the lowering arm and comprises the lowering arm attachment points.

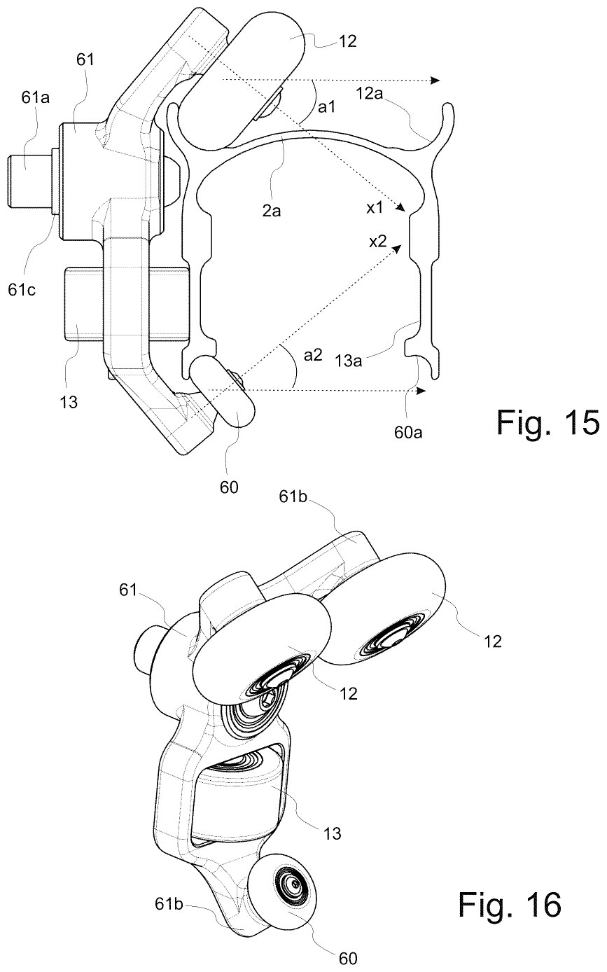

FIG. 15 shows a cross-sectional view of a roller system of the drive unit from FIG. 13 on the guide rail and FIG. 16 shows a perspective view of the roller system from FIG. 15 without the guide rail.

In FIG. 15, a preferred position of the safety roller described above in relation to the guide rollers is best visible. It is provided on an opposite side of the guide rail in relation to the guide roller. In the present case, the guide rollers are arranged on the upper side of the guide rail and the safety roller on the underside of the guide rail. However, other configurations are also conceivable.

All rollers are preferably supported by a common carrier body 61. FIG. 16 shows a preferred design of the carrier body, which comprises a roller bearing 61c with a bolt 61a. The bolt is used to fasten the lowering arm or the roller-side leg of the drive arm in point 11, whereby, as described above, the lowering arm or the roller-side leg of the drive arm has several holes which can be selected as desired by the user for fastening the roller system. It is preferred that the counter roller 13 is mounted directly in the carrier body 61, which reduces the dimensions of the carrier body 61. On the other hand, the guide rollers and the safety roller are each supported by an arm 61b of the roller bearing (double arm). In contrast to the arrangement shown in FIG. 11, which shows the guide roller 12 on the lowering arm and the counter rollers 13 on a transverse profile attached to it, in this embodiment the carrier body is in one piece, preferably cast in one piece, which increases stability and durability. The roller bearing, which carries the entire load, is arranged in the carrier body.

As best seen in FIG. 15, the guide rollers 12 are preferably inclined towards the guide rail in relation to the horizontal. Preferably, a roller axis x1 of the guide roller forms a first angle a1 to the horizontal, as drawn in the figure. This angle is preferably between 25° and 55° and most preferably it is 40°. In general, it can be said in this context that the roller sizes, the shape of the guide rail and the angle a1 are selected in such a way that the forces are distributed as evenly as possible on the guide rail. Simulations have shown, for example, that a vertical arrangement of the guide roller on the guide rail results in increased wear of the guide roller. Therefore, an angle a1 of 0° is preferably excluded. The above-mentioned angle range for al has proven to be advantageous in this respect. The provision of two guide rollers also contributes not only to increased stability but also to reduced wear on each guide roller. On the other hand, only one counter roller and one safety roller are preferably provided, as these do not bear the main load of the user. However, several safety rollers and/or counter rollers could also be provided.

It is further preferred in this embodiment (as shown in FIG. 15) that the roller axis x2 of the safety roller forms a second angle a2 to the horizontal of between 25° and 55°, with the most preferred second angle being 40°. In principle, the term “roller axis” is to be understood in this document as the axis of rotation of the roller.

For each carrier body, the respective second angle a2 of the safety roller is preferably equal in amount to the respective first angle a1 of the guide roller and, in relation to the orientation, it mirrors the angle a1 on the horizontal.

The guide rollers take the main load, which is transferred to the roller bearing. If the force from pedaling were applied exactly under the guide rollers, there would be no torque to be supported and the ideal alignment would be vertical. The further outwards the force from pedaling is applied, the greater the torque and the flatter the angle al of the guide rollers. The guide rollers still bear the entire vertical force from pedaling. However, there is an additional horizontal force for the torque support and this must be balanced with the counter roller. This results in Pedal force further out->angle of the guide rollers becomes flatter (roller axis becomes steeper, angle a1 becomes larger). Pedal force further in->angle of the guide rollers steeper (roller axis becomes flatter, angle a1 becomes smaller). In addition, the relative position of the counter roller to the guide roller also has an influence on the angle. Put simply, if the distance between the rollers is greater, the horizontal force on the guide rollers is smaller and therefore the angle is steeper. This is a compromise between how compact the roller system is and how large the loads on the rollers are. The counter roller can only absorb horizontal forces. With vertical forces, it would slip on the surface. Lateral forces are possible with the guide rollers and the safety roller.

The geometric arrangement and alignment of the guide rails in the frame, the positioning of the crank drive and the flexible drive arms, which are designed in such a way that the depth of the lowering, the length of the drive arm and the pedal attachment can be flexibly adjusted, enable the installation of shorter guide rails, drive arms and cranks. Nevertheless, an optimally long horizontal elliptical path of the foot pedal is achieved and thus an optimal power flow for the user is possible.

The advantage of installing the drive unit in a mobile elliptical trainer is that it is more compact, easy to transport, can be individually adjusted to different body sizes and can used both on the road and off-road. This concept can also be used for a standing or seated version.

While preferred embodiments of the invention are described in the present application, it should be clearly pointed out that the invention is not limited to these and can also be carried out in other ways within the scope of the following claims. In this regard, terms used in the description such as “preferred”, “in particular”, “advantageous”, etc. refer only to optional and exemplary embodiments.

### LIST OF REFERENCE SYMBOLS

1=Frame
2 Frame segment
2a=Guide rail
3a=Mobile training device
3b=Stationary training device
4=Drive unit
5 Bracket
6=Holding device for the rear wheel
7=Reinforcing leg
8=Lowering arm
9=left drive arm
10=right drive arm
11=Lowering arm attachment point
12=Guide roller
12a=first guide groove
13=Counter roller
13a=second guide groove
14=Pedal attachment points on reinforcement leg
15=Pedal attachment point(s) on drive arm
16/1=Coupling points
17/18=left/right pedal
20/21=Left/right crank
22=Coupling-side leg of the drive arm
23=Roller-side leg of the drive arm
30 Front wheel
31=Rear wheel
40=Steering rod/support rod
41=Handlebar/handhold bar
50=Coupling
51=Translation
52=Chain or toothed belt
55=Ellipse of the pedal path
60=Safety roller
60a=third guide groove
61=Carrier body
61a=Bolt
61b=Arms of the carrier body
61c=Roller bearing
IS=Initial swing
MS=Middle swing
TS=Final swing
HS=Heel strike
TO=Toe-off
PS=Forward swing
b=floor centerline
P=Person/user
Z=Crank point
53=Saddle
a1=first angle
a2=second angle
L=Ellipse length
H=Ellipse height

1. Drive unit (4) for driving a wheel (31) of a training device (3a; 3b) by means of a tread force of a user (P) of the training device, wherein the drive unit is designed such that it translates a path described by the human foot during walking or running into an elliptical path (55) for the foot, wherein the drive unit comprises the following:
a left and a right L-shaped or V-shaped drive arm (9, 10),
a left and a right roller system, each comprising at least one roller (12), wherein the left roller system is rotatably connected to the left drive arm and the right roller system is rotatably connected to the right drive arm, each one in the region of a front extremity of the respective drive arm, wherein the at least one roller of each drive arm is received linearly movable back and forth in at least one guide rail (2a) of the drive unit or in at least one guide rail of a frame (2) of the training device,
a coupling (50) with a left and a right crank (20, 21) for transmitting the tread force of the user to the wheel, wherein the coupling is rigidly connected to the left and the right crank at a respective crank point (Z), wherein the left crank is rotatably connected to the left drive arm and the right crank is rotatably connected to the right drive arm in each case in the region of a rear extremity of the respective drive arm,
a left and a right foot pedal (17, 18) for applying the tread force to the drive unit, wherein the left and right foot pedals are attached to the left and right drive arms respectively.

2. Drive unit according to claim 1, wherein the left and the right roller system each comprise a lowering arm (8), wherein the lowering arm is rotatably attached to the at least one roller at an upper end and is rigidly attached to the respective drive arm at the lower end in the region of a front extremity thereof, or wherein the lowering arm is formed by a front extremity of the respective drive arm itself and is rotatably attached to the at least one roller at an upper end, so that the front extremity of the respective drive arm is always lowered relative to the at least one roller.

3. Drive unit according to claim 2, wherein the attachment between each lowering arm and the respective drive arm is adjustable in such a way that a distance between the front extremity of the drive arm and the at least one roller can be changed by the user.

4. Drive unit according to claim 1, wherein the attachment between each crank and the respective drive arm is adjustable in such a way that a distance between the crank point (Z) and the respective coupling point (16; 19) can be changed by the user.

5. Drive unit according to claim 1, wherein the coupling is designed as a toothed wheel for a chain drive or as a pulley for a belt drive and can be mounted on a frame of the training device,
in particular in front of the wheel of the training device to be driven.

6. Drive unit according to claim 1, wherein the left and the right drive arm each comprise a coupling-side leg (22), to which the respective left or right crank is rotatably fastened, and comprise a roller-side leg (23) to which the respective left or right roller system is rotatably fastened, in particular wherein the roller-side leg is longer than the coupling-side leg, wherein either
the coupling-side leg and the roller-side leg are rigidly connected to each other or are in one piece, and are angled towards each other, or
the coupling-side leg and the roller-side leg are in one piece and merge into one another in a curved shape.

7. Drive unit according to claim 6, wherein the pedals are each rotatably attached to the coupling-side leg of the associated drive arm, in particular wherein a position of the pedals can be adjusted by the user along the longitudinal axis of the respective coupling-side leg.

8. Drive unit according to claim 1, wherein the left and the right roller system each has at least one guide roller (12) and at least one counter roller (13), which are offset relative to one another in such a way that the guide roller (12) is accommodated in a first guide groove (12a) of the guide rail and the counter roller (13) is accommodated in a second guide groove (13a) so as to be linearly shiftable back and forth, in particular wherein the guide roller and the counter roller of the roller systems have different diameters, in particular wherein the diameter of the guide roller is greater than the diameter of the counter roller.

9. Drive unit according to claim 8, wherein the left and the right roller system each comprise at least one safety roller (60) which is accommodated in a third guide groove (60a) of the guide rail so as to be shiftable back and forth and which is arranged in relation to a position of the guide roller in such a way that it prevents the roller system from jumping out or being unintentionally removed from the guide rail, in particular wherein the safety roller is provided on an opposite side of the guide rail in relation to the guide roller.

10. Drive unit according to claim 9, wherein the guide roller is inclined with respect to the horizontal towards the guide rail, wherein preferably a roller axis (x1) of the guide roller forms a first angle (a1) between 25° and 55°, most preferably a first angle of 40°, with respect to the horizontal,
wherein a roller axis (x2) of the safety roller forms a second angle (a2) to the horizontal of between 25° and 55°, most preferably a second angle of 40°,
in particular where the first angle and the second angle are equal in value and are mirrored with respect to the horizontal.

11. Training device (3a, 3b), comprising
a frame (1) with at least one chain stay and a frame segment (2), wherein a front end of the chain stay (2a, 2b) is attached to a lower end of the frame segment,
a rear wheel (31) attached to a rear end of the chain stay,
a steering unit (40, 41) or holding unit attached to an upper end of the frame segment, and
a drive unit (4) according to one of the preceding claims,
wherein the frame segment has at least one lateral guide rail (2a) on the left and right sides, in each of which the at least one guide roller (12) of the left or right drive arm of the drive unit is accommodated so as to be linearly shiftable back and forth parallel to a longitudinal axis of the frame segment,
wherein the coupling (50) of the drive unit is rotatably attached to the frame between the frame segment and the rear wheel,
further comprising a power transmission element, in particular a chain (52) or a belt, by means of which a tread force of a user of the training device is transmitted to the rear wheel and causes it to rotate.

12. Training device according to claim 11, wherein the training device (3a) is mobile and further comprises a front wheel (30) which is steerable with the steering unit, or
wherein the training device (3b) is stationary and comprises the holding unit for supporting the user's hands, and further comprises a holding device (6) for the rear wheel so that it can be rotated without contacting the ground.

13. Training device according to claim 11, wherein the length of the coupling-side leg is smaller than the length of the at least one guide rail.

14. Training device according to claim 11, wherein the coupling of the drive unit is arranged on the frame of the training device in front of the rear wheel of the training device to be driven and above the axis of rotation of the rear wheel.

15. Training device according to claim 11, wherein, in case the at least one guide rail is part of the drive unit, the frame segment is designed in such a way that the guide rail can be attached thereto, so that the frame segment and the guide rail form a fixed structural unit.

16. Drive unit according to claim 1, wherein the left and right foot pedals are rotatably attached to the left and right drive arms respectively.
